(19) United States
(12) Patent Application Publication
(10) Pub. No.: US 2022/0237682 A1
(43) Pub. Date: Jul. 28, 2022

(54) SCALABLE ARCHITECTURE FOR RECOMMENDATION

(71) Applicant: ADOBE INC., SAN JOSE, CA (US)

(72) Inventors: Handong Zhao, San Jose, CA (US); Zhankui He, San Diego, CA (US); Zhaowen Wang, San Jose, CA (US); Zhe Lin, Bellevue, WA (US); Ajinkya Kale, San Jose, CA (US); Fengbin Chen, San Jose, CA (US)

(21) Appl. No.: 17/159,554

(22) Filed: Jan. 27, 2021

(51) Int. Cl. G06Q 30/06; G06N 3/04; G06N 3/08; G06K 9/62

(52) U.S. Cl. CPC G06Q 30/0631; G06K 9/6267; G06N 3/08; G06N 3/04

(57) ABSTRACT

Systems and methods for item recommendation are described. Embodiments identify a sequence of items selected by a user, embed each item of the sequence of items to produce item embeddings having a reduced number of dimensions, predict a next item based on the item embeddings using a recommendation network, wherein the recommendation network includes a sequential encoder trained based at least in part on a sampled softmax classifier, and wherein predicting the next item represents a prediction that the user will interact with the next item, and provide a recommendation to the user, wherein the recommendation includes the next item.

### BACKGROUND

The following relates generally to item recommendation, and more specifically to sequential item recommendation using machine learning.

Item recommendation refers to the task of collecting data relating to user interactions, modelling user behavior, and using the model to predict items that users are likely to interact with. For example, the user may click on a sequence of items in an online store, and a website server can predict a next item that the user is likely to view or purchase.

In some cases, neural networks such as transformer-based networks may be used to generate recommendations. These recommendation networks are often trained using relatively small public datasets. However, the training techniques used by these recommendation networks are computationally intensive, and cannot be scaled for use with large scale, industrial databases. Techniques such as binary classification have been proposed to improve scalability, but these techniques lead to a much slower convergence speed or a significant drop in accuracy. Therefore, there is a need in the art for an improved recommendation network that is scalable, accurate, and can be trained efficiently on large-scale datasets.

### SUMMARY

The present disclosure describes systems and methods for item recommendation. Embodiments of the disclosure provide a recommendation network that includes a sequential encoder. The encoder is trained using a sampled softmax layer that is smaller in size than a conventional softmax layer. In some embodiments, a dense projection layer of the recommendation network is removed to increase inference speed and avoid over-fitting.

A method, apparatus, and non-transitory computer readable medium for item recommendation are described. Embodiments of the method, apparatus, and non-transitory computer readable medium are configured to identify a sequence of items selected by a user, embed each item of the sequence of items to produce item embeddings having a reduced number of dimensions, predict a next item based on the item embeddings using a recommendation network, wherein the recommendation network comprises a sequential encoder trained based at least in part on a sampled softmax classifier, and wherein predicting the next item represents a prediction that the user will interact with the next item, and provide a recommendation to the user, wherein the recommendation includes the next item.

An apparatus and method for item recommendation are described. Embodiments of the apparatus and method include an embedding layer configured to embed a sequence of items from a session into an embedding space to produce a session embedding, a transformer block configured to encode the session embedding to produce a session encoding, and an output layer configured to predict a next item for a session based on the session encoding, wherein a recommendation network is trained based at least on a sampled softmax classifier of the output layer.

A method, apparatus, and non-transitory computer readable medium for training a recommendation network are described. Embodiments of the method, apparatus, and non-transitory computer readable medium are configured to identify a plurality of training sessions, wherein each training session comprises a sequence of items, predict a plurality of logits for each of the training sessions using a recommendation network, sample a subset of the logits, apply a sampled softmax classifier based on the sampled subset of the logits, and update parameters of the recommendation network based on the sampled softmax classifier.

### BRIEF DESCRIPTION OF THE DRAWINGS

FIG. 1 shows an example of a system for item recommendation according to aspects of the present disclosure.

FIG. 2 shows an example of a process for item recommendation according to aspects of the present disclosure.

FIG. 3 shows an example of an apparatus for item recommendation according to aspects of the present disclosure.

FIG. 4 shows an example of a recommendation network according to aspects of the present disclosure.

FIG. 5 shows an example of a transformer layer according to aspects of the present disclosure.

FIG. 6 shows an example of a process for item recommendation according to aspects of the present disclosure.

FIG. 7 shows an example of a process for training a recommendation network according to aspects of the present disclosure.

### DETAILED DESCRIPTION

The present disclosure describes systems and methods for item recommendation. Embodiments of the disclosure provide a recommendation network that includes a sequential encoder. The encoder is trained using a sampled softmax layer that is smaller in size than a conventional softmax layer. In some cases, the sampling is performed on a graphics processing unit (GPU) to increase training speed. A dense projection layer of the recommendation network may be removed to increase inference speed and avoid over-fitting.

Sequential recommendation systems provide item recommendations to users by modeling the user's sequential interactions (e.g., a “clicks chain”). Some recommendation systems depend on deep neural networks (e.g., gated recurrent units (GRUs), Long Short-Term Memory (LSTM), and Transformer) to capture sequential patterns. Recent recommendation systems have applied bidirectional encoder representations from transformers (BERT) to the sequential recommendation task.

However, transformer-based recommendation systems such as those based on a BERT architecture (e.g., BERT4Rec) are not able to process large-scale datasets because the training efficiency is too low. One reason for this inefficiency is that the softmax layer used by these networks is inefficient when used for large-scale datasets. As a result, training on an industrial scale dataset may take hundreds or thousands of times longer than with the relatively small public datasets traditionally used for training recommendation networks. One of the reasons for this inefficiency is that conventional recommendation systems use a computationally intensive softmax classifier. However, bypassing the softmax layer leads to slower convergence speed and decreased accuracy compared to using a softmax layer.

Embodiments of the present disclosure include an improved recommendation network that solves the scalability issue while maintaining competitive accuracy and performance. The recommendation network is trained using a sampled softmax layer. The sampled softmax technique accelerates the softmax calculation by sampling a subset of the logits and applying a sampled softmax classifier based on the sampled subset of the logits. In some examples, the network is trained by decomposing the gradient of log-likelihood values into two parts: the positive and negative contributions. One embodiment of the present disclosure is configured to perform the sampling using one or more GPUs. The disclosed training methods result in a decrease in training time without substantially compromising accuracy.

According to one embodiment, an encoder of the recommendation network is based on a BERT architecture. However, unlike existing BERT encoders, embodiments of the present disclosure eliminate the dense projection layer to achieve a smaller model size, which leads to faster inference speed and alleviates the over-fitting issue of conventional recommendation networks.

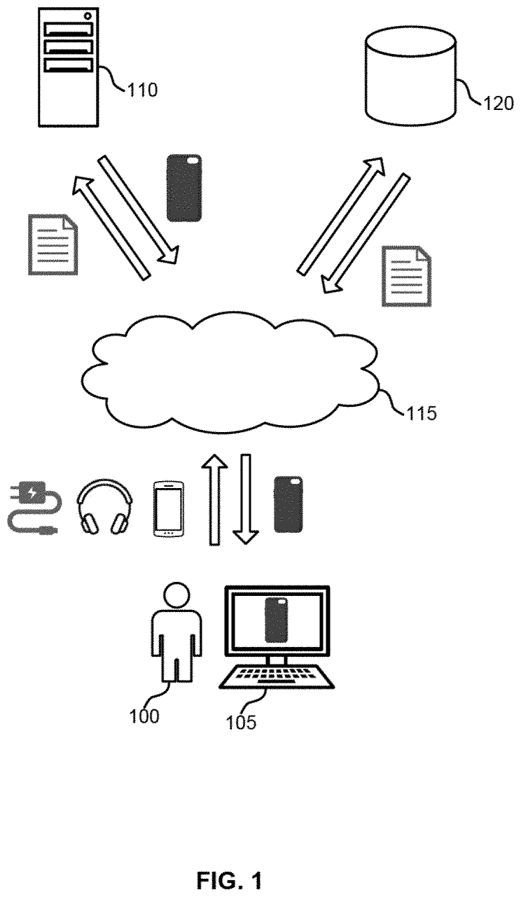

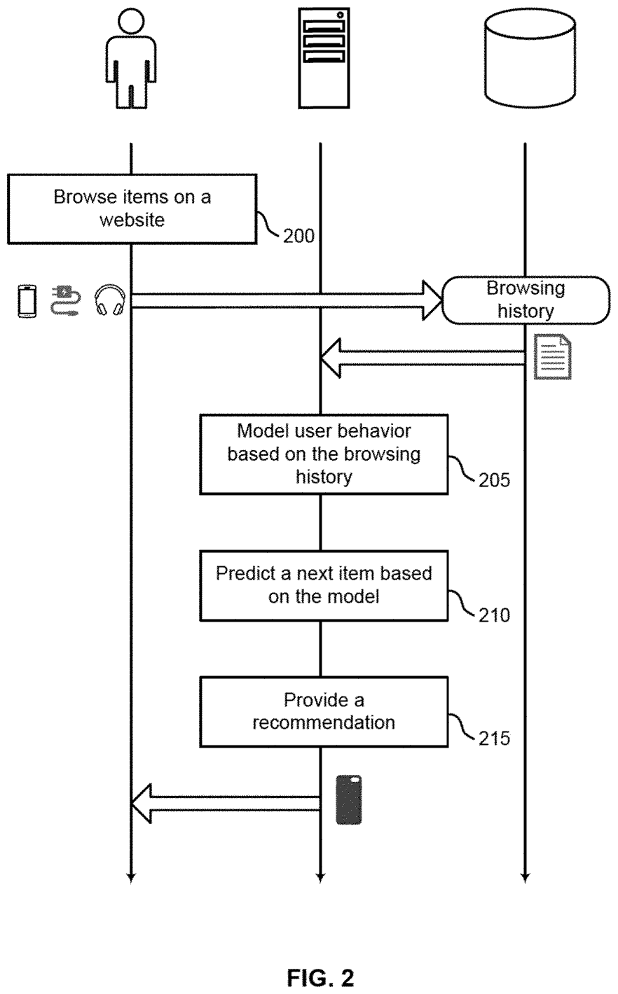

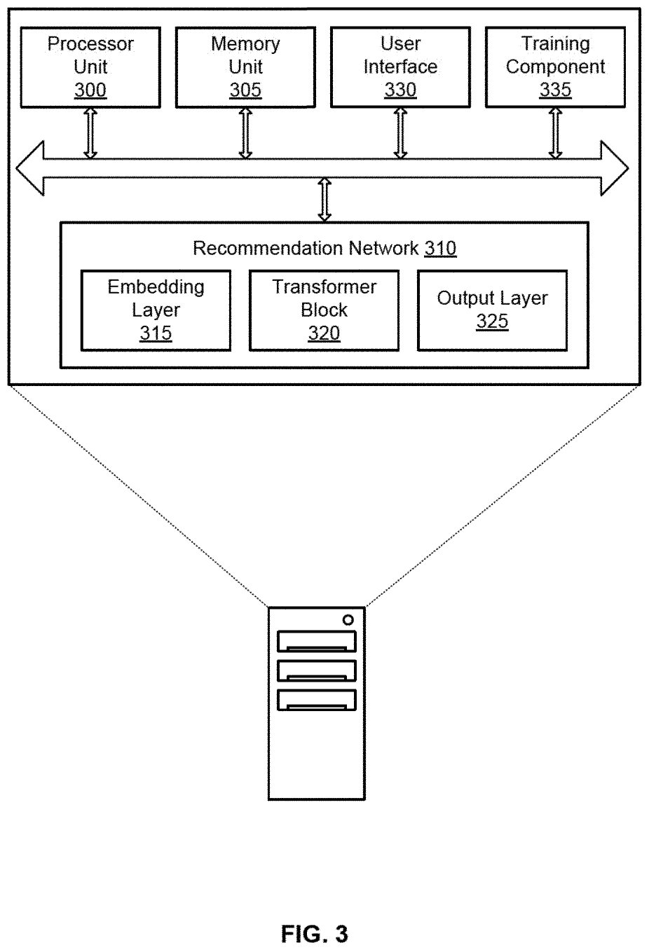

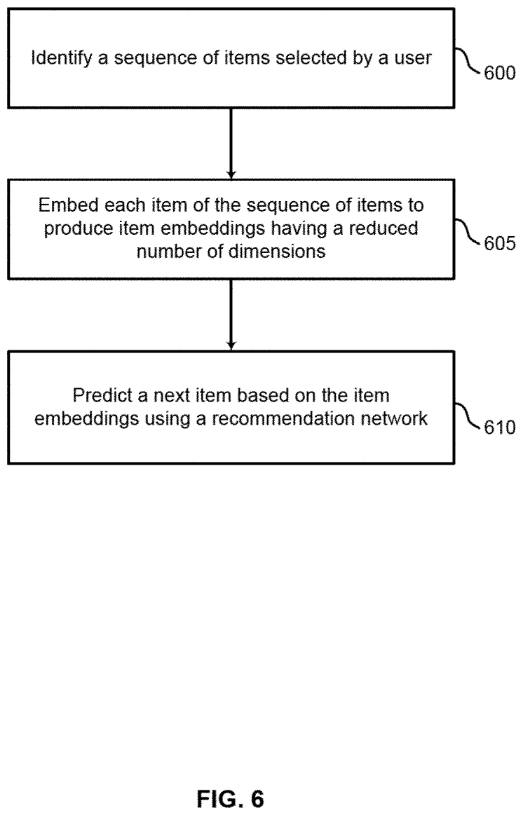

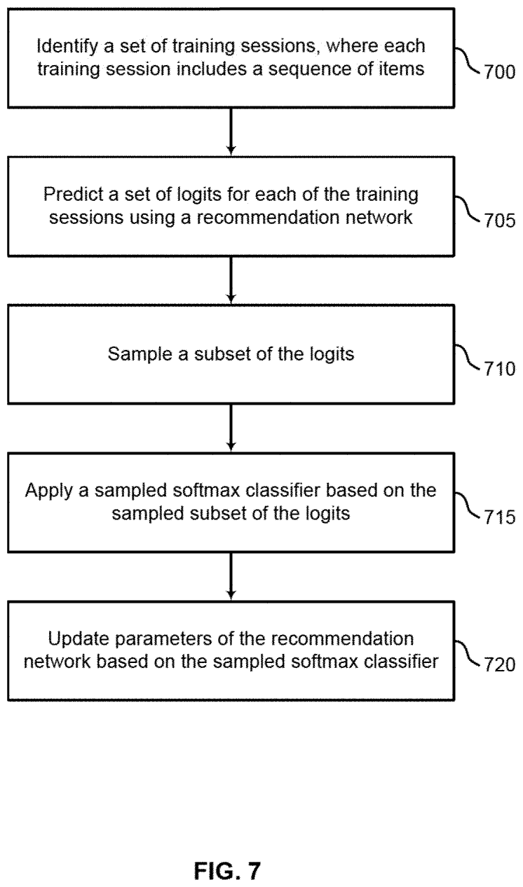

Embodiments of the present disclosure may be used in the context of website browser for item recommendation. For example, a recommendation network may take a sequence of items a user views as input, and recommend an item that a user is likely to interact with next. An example application of the inventive concept in the website server context is provided with reference to FIGS. 1 and 2. Details regarding the architecture of an example recommendation network are provided with reference to FIGS. 3, 4, and 5. An example of the process for using the recommendation network is provided with reference to FIG. 6. A description of an example training process is described with reference to FIG. 7.

### Item Recommendation

FIG. 1 shows an example of a system for item recommendation according to aspects of the present disclosure. The example shown includes user 100, user device 105, recommendation network 110, cloud 115, and database 120. Recommendation network 110 is an example of, or includes aspects of, the corresponding element described with reference to FIG. 3.

In the example of FIG. 1, a sequence of items are viewed by a user 100 on a website browser, i.e., using the user device 105. Each of the items on the browser may represent a commercial item for sale on a website (e.g., a phone charger, a headset, and smart phone). The number of items in the sequence of items is at least one, and generally more than one. In some examples, the sequence of items includes media representations of different types (e.g., audio file, video files, and image files) that are presented on the website.

In some cases, the sequence of items constitutes a session of the user arranged in a chronological order. Additionally or alternatively, a session includes a sequence of items and the sequence of items depends on a portion of the user's browsing history with the website. For example, the sequence of items includes an order history of the user on an e-commerce website (e.g., Amazon® online shopping) having purchased a smart phone, a phone charger and a headset as illustrated in FIG. 1, or alternatively, a sequence of songs or videos selected by a user.

The user 100 communicates with the recommendation network 110 via the user device 105 and the cloud 115. For example, the user 100 may select a sequence of items displayed on the user device 105. The items may include audio, video or image files. In the example illustrated in FIG. 1, the sequence of items includes representations of a phone charger, a headset, and a smart phone.

The recommendation network 110 collects the browsing history, including the sequence of items viewed by the user, to make a recommendation of a next item to be viewed by the user. The browsing history (represented by a document icon) may correspond to a list of searchable objects stored within the database 120. In some examples, a data structure such as an array, a matrix, a tuple, a list, a tree or a combination thereof may be used to represent the sequence of items.

The recommendation network 110 identifies or generates item embeddings for the sequence of items. Then, the recommendation network 110 predicts a next item based on the sequence of item embeddings. A predicted next item (i.e., a representation of a phone case) is returned to be displayed on the user device 105. The process of using the recommendation network 110 to perform item recommendation is further described with reference to FIG. 2.

A recommendation represents an item that the recommendation network predicts the user is likely to interact with. In some examples, the recommendation includes a product that a user is likely to click on or purchase based on the user's browsing history or order history (e.g., on an e-commerce website). In some other examples, the recommendation includes an image that the recommendation network predicts the user will interact with based on the user's viewing history (e.g., when the user searches images on an image search engine such as Adobe® Stock).

The user device 105 may be a personal computer, laptop computer, mainframe computer, palmtop computer, personal assistant, mobile device, or any other suitable processing apparatus. The user device 105 may also include a website browser that a user interacts with to run searches.

According to some embodiments of the present disclosure, the recommendation network 110 includes a computer implemented artificial neural network (ANN) that identifies a sequence of items selected by a user 100, embeds each item of the sequence of items to produce item embeddings having a reduced number of dimensions (i.e., a reduced number of dimensions relative to the size of the original media file the user 100 interacted with), predicts a next item based on the item embeddings, and provides a recommendation to the user 100 that includes the next item.

An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

The architecture of the recommendation network may be based on a sequential encoder such as a transformer network, a recurrent neural network (RNN), or a LSTM. In some examples, the recommendation network 110 is based on a bidirectional encoder representations from transformers (BERT) architecture. According to some embodiments, the recommendation network 110 includes an embedding layer, a transformer block, and an output layer. The embedding layer takes the sequence of items as input and generates session embedding corresponding to the sequence. The transformer block takes the session embedding as input and generates session encoding. The output layer takes session encoding as input and generates a prediction result (i.e., recommendation).

The recommendation network 110 may also include a processor unit, a memory unit, a user interface, and a training component. The training component is used to train a sequential encoder of the recommendation network 110. Additional details regarding the architecture of an example recommendation network are provided with reference to FIGS. 3, 4, and 5, and an example of a process for using the recommendation network is provided with reference to FIG. 6.

In some examples, a training component is used to train the sequential encoder of the recommendation network 110. A sampled softmax classifier is used during training to process datasets having large batch size, save GPU memory, and prevent accuracy loss. After training, the trained sequential encoder is used to generate item embeddings for each item of the sequence of items.

During the training process, the parameters and weights of the recommendation network 110 are adjusted to increase the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

In some cases, the recommendation network 110 is trained using a sampled softmax classifier. A sampled softmax technique is provided to accelerate the softmax calculation through sampling a subset of the logits generated by the encoder. In some cases, the training method is based on decomposing gradient of the log-likelihood into positive and negative contributions. A training-based-on-sampling method (e.g., adaptive importance sampling) may be used to decrease training time and increase the training efficiency. According to some embodiments, recommendation network 110 predicts a set of logits for each of the training sessions. Further detail regarding the training of the recommendation network is provided with reference to FIG. 7.

In some cases, the recommendation network 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

A cloud 115 is a computer network configured to provide on-demand availability of computer system resources, such as data storage and computing power. In some examples, the cloud 115 provides resources without active management by the user. The term cloud 115 is sometimes used to describe data centers available to many users over the Internet. Some large cloud networks have functions distributed over multiple locations from central servers. A server is designated an edge server if it has a direct or close connection to a user 100. In some cases, a cloud 115 is limited to a single organization. In other examples, the cloud 115 is available to many organizations. In one example, a cloud 115 includes a multi-layer communications network comprising multiple edge routers and core routers. In another example, a cloud 115 is based on a local collection of switches in a single physical location.

A database 120 is an organized collection of data. For example, a database 120 stores data in a specified format known as a schema. A database 120 may be structured as a single database, a distributed database, multiple distributed databases, or an emergency backup database. In some cases, a database controller may manage data storage and processing in a database 120. In some cases, a user interacts with database controller. In other cases, database controller may operate automatically without user interaction. In some examples, the database 120 includes input sequence data, which may correspond to a sequence of items that the user has browsed on an e-commerce website.

FIG. 2 shows an example of a process for item recommendation according to aspects of the present disclosure. In some examples, these operations are performed by a system such as the item recommendation system of claim 1. The system may include a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 200, the user browses items on a website. According to an example, the user may be interested in buying a sequence of items including a phone charger, a headset, and a smart phone. The user browses an e-commerce website (e.g., Amazon® online shopping) in search of such items. In some examples, the user saves the sequence of items in a virtual shopping cart or purchases an item from the sequence of items. In some cases, a third-party e-commerce website has an order history page keeping track of the user's previous purchasing history (the “browsing history” is also represented by a document icon as in the example illustrated in FIG. 2). In some cases, the operations of this step refer to, or may be performed by, a user interface as described with reference to FIG. 3.

At operation 205, the system models user behavior based on the browsing history. The system is configured to analyze trend of the user's purchasing behavior. In one example, the recommendation network 110 recommends relevant smart phone accessories to a user given that the user has purchased a smart phone and a headset. In some cases, the operations of this step refer to, or may be performed by, a recommendation network as described with reference to FIGS. 1 and 3.

According to some embodiments of the present disclosure, the recommendation network 110 characterizes the user's interests accurately, even where the user's interests may be evolving and dynamic. To model such sequential dynamics in user behaviors, the recommendation network 110 makes predictions based on users' historical interactions. In some examples, the recommendation network 110 includes sequential neural networks configured to generate sequential recommendation.

At operation 210, the system predicts a next item based on the model. The next item is an item that the user is likely to interact with (e.g., item of preference). In some examples, the system predicts a next item that the user is likely to view and purchase based on the user's order history. According to the example above, the system makes its prediction based on the user's browsing history on an e-commerce website (e.g., saved items in the virtual shopping cart, browsing history, and/or order history). In some cases, the operations of this step refer to, or may be performed by, a recommendation network as described with reference to FIGS. 1 and 3.

In some examples, the system applies a sequential recommendation network such as an RNN to increase the recommendation accuracy by making use of the user sequential dynamics (e.g., a clicks chain). In other examples, deep neural network sequential models (GRUs, LSTMs, Transformer) can also be used to effectively capture sequential patterns.

According to some embodiments, the recommendation network 110 includes a language representation model (e.g., a BERT model), which is configured to pretrain deep bidirectional representations from unlabeled text by jointly conditioning on both left and right context in all layers. In some embodiments, a pre-trained BERT model may be fine-tuned with an additional output layer. Embodiments of present disclosure include applications such as question answering systems and language inference systems, but are not limited to these applications.

At operation 215, the system provides a recommendation based on the predicted next item. According to the example above, the system provides the user with a smart phone protective case as a recommended item. The system sends a promotion email enclosing the smart phone case item, and/or the system displays a smart phone protective case in the advertising section of the e-commerce website (e.g., Amazon® online shopping) on the user's monitor. In some cases, the operations of this step refer to, or may be performed by, a user interface as described with reference to FIG. 3.

### Network Architecture

FIG. 3 shows an example of an apparatus for item recommendation according to aspects of the present disclosure. The example shown includes processor unit 300, memory unit 305, recommendation network 310, user interface 330, and training component 335. Recommendation network 310 is an example of, or includes aspects of, the corresponding element described with reference to FIG. 1.

In one embodiment, recommendation network 310 includes embedding layer 315, transformer block 320, and output layer 325. According to this embodiment, embedding layer 315 is configured to embed a sequence of items from a session into an embedding space to produce a session embedding, a transformer block 320 is configured to encode the session embedding to produce a session encoding, and an output layer 325 is configured to predict a next item for a session based on the session encoding, wherein a recommendation network is trained based at least on a sampled softmax classifier of the output layer.

A processor unit 300 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor unit 300 is configured to operate a memory array using a memory controller. In other cases, a memory controller is integrated into the processor unit 300. In some cases, the processor unit 300 is configured to execute computer-readable instructions stored in a memory to perform various functions. In some embodiments, a processor unit 300 includes special purpose components for modem processing, baseband processing, digital signal processing, or transmission processing.

Examples of a memory unit 305 include random access memory (RAM), read-only memory (ROM), or a hard disk. Examples of memory unit 305 include solid state memory and a hard disk drive. In some examples, memory unit 305 is used to store computer-readable, computer-executable software including instructions that, when executed, cause a processor to perform various functions described herein. In some cases, the memory unit 305 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory unit 305 store information in the form of a logical state.

According to some embodiments, embedding layer 315 embeds each item of the sequence of items to produce item embeddings having a reduced number of dimensions. In some examples, embedding layer 315 combines the item embeddings to form a session embedding, where the transformer block 320 takes the session embedding as an input.

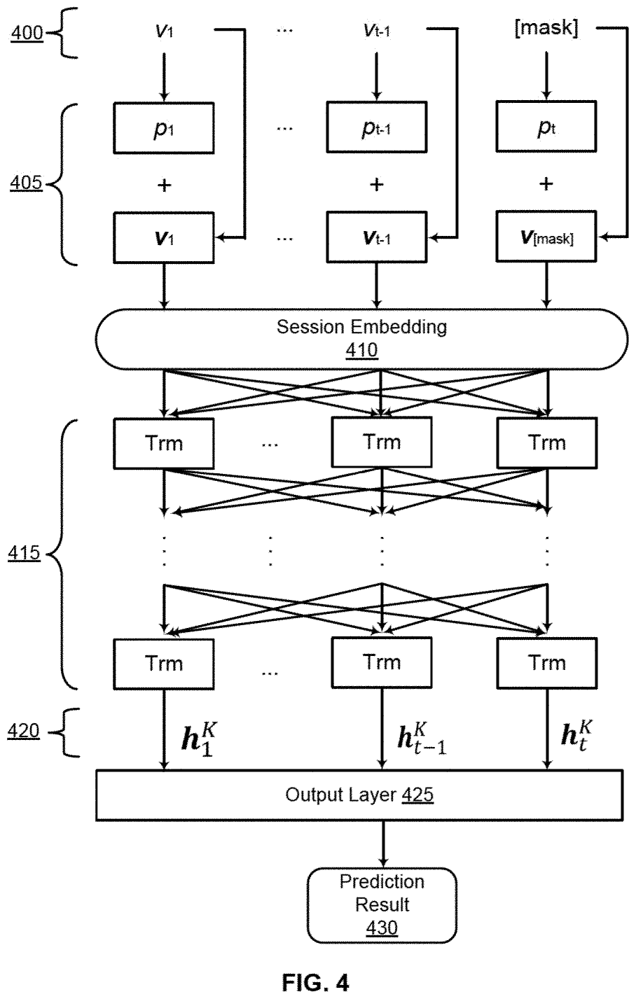

According to some embodiments, embedding layer 315 is configured to embed a sequence of items from a session into an embedding space to produce a session embedding. The embedding layer 315 embeds each item of the sequence into a low-dimensional embedding space to produce item embeddings, where the low-dimensional embedding space has fewer dimensions than an item from the sequence. In some examples, embedding layer 315 combines the item embeddings to form a session embedding. Embedding layer 315 is an example of, or includes aspects of, the corresponding element described with reference to FIG. 4.

According to an embodiment, the embedding layer 315 is constructed by item embeddings and positional embeddings to embed the item id into a low-dimensional space. A sequence of items is input to the embedding layer 315 to produce session embedding.

According to some embodiments, transformer block 320 encodes the session embedding to produce a session encoding, where the session encoding includes contextual information from the sequence of items. In some examples, the transformer block 320 includes a set of transformer modules, each of the transformer modules includes a multi-head self-attention layer and a position-wise feed-forward layer. Transformer block 320 is an example of, or includes aspects of, the corresponding element described with reference to FIG. 4.

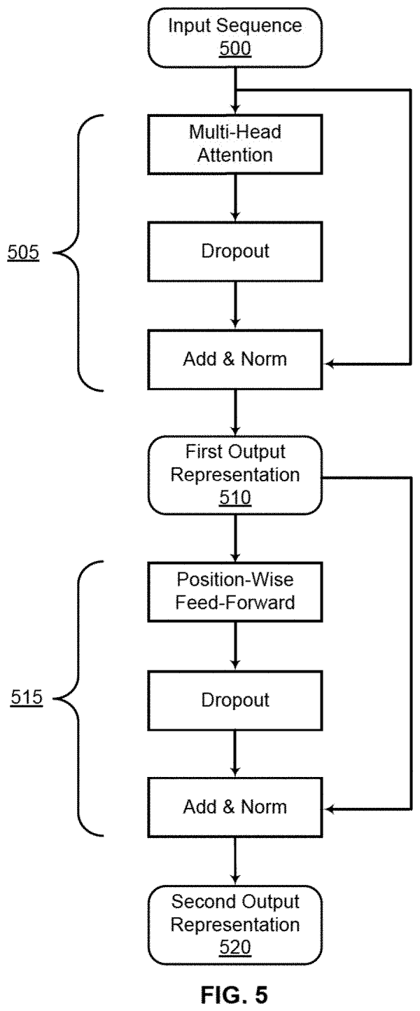

According to an embodiment, transformer block 320 is formed by stacking a set of transformer layers. In one example, each transformer layer (also labeled as Trm) includes two sub-layers, which include a multi-head self-attention sub-layer and a position-wise feed-forward network. In some examples, the transformer block 320 has a total of L transformer layers. Detail regarding the two sub-layers will be described with reference to FIG. 5.

According to some embodiments, output layer 325 applies a classifier to the session encoding, where the next item is selected based on the classifier. According to some embodiments, output layer 325 is configured to predict a next item for a session based on the session encoding.

In some examples, the output layer 325 does not include a projection layer. For example, the dense projection layer may be removed to obtain a smaller model size, which leads to faster inference speed and alleviates the over-fitting problem.

In some cases, a sampling method (e.g., adaptive importance sampling) is used to accelerate training of a neural probabilistic language model. According to an embodiment, the recommendation network 310 applies a sampled softmax technique. In some examples, the network model samples N negatives (e.g., N=1K) to construct softmax candidates. Compared with the full-softmax, the layer size is relatively small so that it converges faster while maintaining competitive accuracy.

The sampling operation costs additional overhead for the training of the recommendation network 310, which is slow on CPUs. With the help of parallel computing devices, the training is implemented on GPUs to run faster and therefore, GPUs make the large-scale training practical. In some examples, output layer 325 is implemented using at least one graphics processing unit (GPU) configured to perform sampling for the sampled softmax classifier.

According to some embodiments, output layer 325 samples a subset of the logits. In some examples, output layer 325 applies a sampled softmax classifier based on the sampled subset of the logits. In some examples, the sampling is based on a negative sampling technique. In some examples, the sampling is performed using a GPU. In some examples, output layer 325 samples a different random subset of the logits during each of the set of iterations. Output layer 325 is an example of, or includes aspects of, the corresponding element described with reference to FIG. 4.

According to some embodiments, user interface 330 identifies a sequence of items selected by a user. For example, the sequence of items includes a phone charger, a headset, and a smart phone. The sequence of items may represent what the user is currently searching for on an e-commerce website and/or represent what the user has already purchased. Through the user interface, the user can communicate with the database and the cloud (see FIG. 1). The user interface 330 is able to access data stored in the database. In some cases, the user interface 330 can communicate with a third-party website through the cloud or communication networks, and has access to order history of the user, wherein the prediction of a next item is based in part on such order history. In some examples, user interface 330 provides a recommendation to the user, where the recommendation includes the next item. In some examples, the items include audio, video, or image files.

According to some embodiments, training component 335 identifies a set of training sessions, where each training session includes a sequence of items. In some examples, training component 335 updates parameters of the recommendation network 310 based on the sampled softmax classifier. In some examples, training component 335 computes a gradient of the parameters based on the subset of the logits, where the sampled softmax classifier is based on the gradient of the parameters. In some examples, training component 335 updates the parameters during a set of iterations to train the recommendation network 310.

According to example embodiments, a method of providing an apparatus for item recommendation includes providing an embedding layer configured to embed a sequence of items from a session into an embedding space to produce a session embedding, a transformer block configured to encode the session embedding to produce a session encoding, and an output layer configured to predict a next item for a session based on the session encoding, wherein a recommendation network is trained based at least on a sampled softmax classifier of the output layer.

In some examples, the embedding layer is configured to embed each item of the sequence into a low-dimensional embedding space to produce item embeddings, wherein the low-dimensional embedding space has fewer dimensions than an item from the sequence. In some examples, the transformer block comprises a plurality of transformer modules, each of the transformer modules comprises a multi-head self-attention layer and a position-wise feed-forward layer.

In some examples, the recommendation network 310 is based on a bidirectional encoder representations from transformers (BERT) architecture. In some examples, the output layer does not include a projection layer. Some examples of the apparatus and method described above further include at least one graphics processing unit (GPU) configured to perform sampling for the sampled softmax classifier.

The described systems and methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

FIG. 4 shows an example of a recommendation network according to aspects of the present disclosure. The example shown includes sequence of items 400, embedding layer 405, session embedding 410, transformer block 415, session encoding 420, output layer 425, and prediction result 430.

According to an embodiment, the recommendation network is based on a bidirectional encoder representations from transformers (BERT) architecture. In some examples, BERT is used as a language representation model, and is configured to pretrain deep bidirectional representations from unlabeled text by jointly conditioning on both left and right context in all layers. As a result, the pre-trained BERT model can be finetuned with an additional output layer to create network models for specific tasks (e.g., question answering and language inference).

In some examples, BERT uses a masked language model (MLM or Masked LM) pre-training objective to alleviate the unidirectionality constraint. The masked language model randomly masks some of the tokens from the input, and the objective is to predict the original vocabulary id of the masked word based only on its context. Unlike left-to-right language model pre-training, the MLM objective enables the representation to fuse the left and the right context, which pretrains a deep bidirectional transformer. In addition to the masked language model, BERT includes a next sentence prediction (NSP) task that jointly pretrains text-pair representations.

A BERT model may also be applied to a recommendation task. A BERT recommendation network may learn based on a bidirectional model, while other sequential networks are limited to left-to-right unidirectional models which predict next item sequentially. For example, a two-layer transformer decoder (i.e., Transformer language model) may be used to capture user's sequential behaviors (i.e., for sequential recommendation). In some cases, a transformer model may be a unidirectional model using a casual attention mask.

According to an embodiment, the recommendation network is stacked by L bidirectional transformer layers. At each layer, it iteratively revises the representation of every position by exchanging information across all positions at the previous layer in parallel with the transformer layer.

According to an embodiment, the transformer layer is not aware of the order of the input sequence. To make use of the sequential information of the input, the recommendation network injects positional embeddings into the input item embeddings at the bottoms of the transformer layer stacks. For a given item, its input representation is constructed by summing the corresponding item and positional embedding.

According to an embodiment, from input to output, the recommendation network includes embedding layer 405, transformer block 415, and output layer 425. As illustrated in FIG. 4, sequence of items 400 is input to the embedding layer 405 to generate session embedding 410. Then, the session embedding 410 is input to the transformer block 415 to generate session encoding 420. The session encoding 420 is input to the output layer 425 to produce the prediction result 430. The embedding layer 405 may include item embeddings and positional embeddings to embed the item id into a low-dimensional space.

According to an embodiment, each transformer layer of transformer block 415 includes two sub-layers, which include a multi-head self-attention sub-layer and a position-wise feed-forward network. The transformer layer will be described in greater detail in FIG. 5.

According to an embodiment, the output layer 425 combines a projection layer and the softmax layer. The projection layer may be a fully connected layer with GELU as activation. However, the projection layer may be removed according to certain embodiments.

FIG. 5 shows an example of a transformer layer according to aspects of the present disclosure. The example shown includes input sequence 500, multi-head self-attention layer 505, first output representation 510, position-wise feed-forward layer 515, and second output representation 520.

Given an input sequence of length t, the network model in some embodiments iteratively computes hidden representations at each layer for each position simultaneously by applying the transformer layer. Here, the network model stacks hidden representations together into a matrix H since the network model computes attention function on all positions simultaneously. According to an embodiment, the transformer layer (or Trm) includes two sub-layers, which include a multi-head self-attention layer 505 and a position-wise feed-forward network 515.

According to an embodiment, the recommendation network includes the multi-head self-attention layer 505. According to an embodiment, attention mechanisms are used in the network model, which can capture the dependencies between representation pairs without regard to their distance in the sequences. It is beneficial to jointly attend to information from different representation subspaces at different positions. The network model includes the multi-head self-attention. In some cases, multi-head attention first linearly projects the matrix H into h subspaces, with different, learnable linear projections, and then apply h attention functions in parallel to produce the output representations which are concatenated and once again projected, where the projection matrices for each head are learnable parameters.

According to an embodiment, the recommendation network includes the position-wise feed-forward layer 515. The self-attention sub-layer mentioned above is mainly based on linear projections. To equip the model with nonlinearity and interactions between different dimensions, the network model applies a position-wise feed-forward network to the outputs of the self-attention sub-layer, separately and identically at each position. It includes two affine transformations with a gaussian error linear unit (GELU) activation in between. In some cases, a smoother GELU activation is used rather than the standard rectified linear unit (ReLu) activation.

The recommendation network can capture item-item interactions across the entire user behavior sequence using self-attention mechanism. The network model can learn more complex item transition patterns by stacking the self-attention layers. However, as it goes deeper, it becomes more challenging to train the network model. Therefore, the network model employs a residual connection around each of the two sublayers, followed by layer normalization. Moreover, dropout is applied to the output of each sub-layer, before it is normalized. The network model normalizes the inputs over all the hidden units in the same layer for stabilizing and accelerating the network training. The recommendation network includes stacking a set of transformer layers (each transformer layer is also denoted as Trm). The set of transformer layers in its entirety is also referred to as the transformer block 415 as illustrated in FIG. 4.

According to an embodiment, as illustrated in FIG. 5, the input sequence 500 is input to the multi-head self-attention layer 505 to generate the first output representation 510. Then, the first output representation 510 is input to the position-wise feed-forward layer 515 to generate the second output representation 520.

FIG. 6 shows an example of a process for item recommendation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

A method for item recommendation is described. Embodiments of the method are configured to identify a sequence of items selected by a user, embed each item of the sequence of items to produce item embeddings having a reduced number of dimensions, predict a next item based on the item embeddings using a recommendation network, wherein the recommendation network comprises a sequential encoder trained based at least in part on a sampled softmax classifier, and wherein predicting the next item represents a prediction that the user will interact with the next item, and provide a recommendation to the user, wherein the recommendation includes the next item.

At operation 600, the system identifies a sequence of items selected by a user. According to an example, a user interface of the system identifies a sequence of items such as phone charger, headset, and a smart phone. The sequence of items may be selected by the user. In some cases, the sequence of items may come from a third-party website (e.g., user's purchase history on an e-commerce website). In some cases, the operations of this step refer to, or may be performed by, a user interface as described with reference to FIG. 3.

According to some embodiments, a recommendation network uses S={s₁, s₂, . . . , s_{|S|}} to denote a set of sessions and I={i₁, i₂, . . . , i_{|I|}} to represent a set of items. Each session sⱼ=(i₁^{(j)}, . . . , iₜ^{(j)}, . . . , iₙ_{ⱼ}^{(j)}) includes the chronological sequence of item interaction, where sⱼ∈S and iₜ^{(j)}∈I. The network model is configured to solve a next-item prediction task, i.e., given the interaction history of session sⱼ, predict the next item iₙ_{ⱼ₊}1^{(j)}. In some cases, the recommendation network is also referred to as a network model.

At operation 605, the system embeds each item of the sequence of items to produce item embeddings having a reduced number of dimensions. According to an embodiment, an embedding layer of the recommendation network is used. The embedding layer is constructed by item embeddings and positional embeddings to embed an item id into a low-dimensional space. In some cases, the operations of this step refer to, or may be performed by, an embedding layer as described with reference to FIGS. 3 and 4.

Given item iₜ^{(j)}=iₖ where the time step is t, the embedding is:

h_{j,t}⁰=pₜ+vᵢ_{ₜ}^{(j)} (1)

where vᵢ_{ₖ}∈V_{|l|×d} and pₜ∈P_{l×d} are both d-dimensional vector, and here l represents the maximal length of the sessions. vᵢ_{ₖ} is the d-dimensional embedding for item iₖ. The positional embedding matrix P allows the network model to identify which portion of the input it is dealing with. The embeddings of session sⱼ are denoted as Hⱼ⁰=(h_{j,1}⁰, . . . , h_{j,l}⁰).

Given an input sequence of length t, the network model iteratively computes hidden representations at each layer for each position simultaneously (e.g., by applying a transformer layer). Here, the network model stacks hidden representations together into a matrix H since the network model computes attention function on all positions simultaneously.

According to an embodiment, a transformer block may be formulated as a black-box function:

Hⱼ^{k}=TRM(Hⱼ^{k-1}),k∈[1,2, . . . ,K] (2)

As Hⱼ⁰, the final output Hⱼ^{K} is the same size l×d to encode the contextual information of session sⱼ into each item embedding h_{j,t}^{K}.

After L layers that hierarchically exchange information across all positions in the previous layer, the network model obtains the final output for all items of the input sequence. Assuming that the recommendation network or user masks the item it at time step t, the network model predicts the masked items iₜ based on hₜ^{L}. In some embodiments, a two-layer feed-forward network is applied with GELU activation in between to produce an output distribution over target items.

At operation 610, the system predicts a next item based on the item embeddings using a recommendation network, where the recommendation network includes a sequential encoder trained based on a sampled softmax classifier, and where predicting the next item represents a prediction that the user will interact with the next item. In some cases, the operations of this step refer to, or may be performed by, a recommendation network as described with reference to FIGS. 1 and 3.

According to the mask language modeling task in BERT training, the recommendation network predicts the probability of the masked target item over all possible items as follows:

p_{j,t}=PROJ(h_{j,t}^{K})=GELU(W_{P}^{T}h_{j,t}^{K}+bₚ) (3)

P(i)=softmaxᵢ(Vp_{j,t}^{T}+b_{O}) (4)

where Wₚ is a learnable projection matrix, and b_{P}, b_{O} are the bias terms.

In some cases, the recommendation network applies the shared item embedding V in the embedding and output layer to alleviate overfitting and reduce model size. In some examples, a softmax function is used as the activation function of the neural network to normalize the output of the network to a probability distribution over predicted output classes. After applying the softmax function, each component of the feature map is in the interval (0, 1) and the components add up to one. These values may be interpreted as probabilities.

According to some embodiments, the projection layer is removed to reduce the model size. Therefore, the output layer may be formulated as follows:

P(i)=softmaxᵢ(Vh^{K}_{j,t}^{T}+b_{O}) (5)

In some cases, the projection layer is used in the original transformer block and applied in some model architecture. For example, during BERT training in natural language processing (NLP), the projection layer is combined with a softmax classifier to transfer the pre-trained BERT for different down-streaming tasks, so different projection layers are needed for task-tailored fine-tuning. But in the sequential recommendation setting, the recommendation network is trained for the single specific next-item prediction task without any transferring or pre-training. Therefore, it is feasible to remove the projection layer.

From empirical observations, due to the sparsity of real-world dataset, sequential recommendation models with projection layer suffer from the overfitting problem. Experiments show that removing the projection layer can reduce the model size and improve the generalization of the network model on real-world datasets consistently.

According to an embodiment, the recommendation network applies sampled softmax (e.g., during training of the network model). In some examples, the recommendation network samples N negatives (e.g., N=1K) to construct softmax candidates. Compared with the full-softmax, the layer size is much smaller. Compared with other conventional methods, the network model using sampled softmax technique converges faster and leads to almost no accuracy drop.

In some examples, the system then provides a recommendation to the user, where the recommendation includes the next item. The recommendation network predicts a next item that the user is likely to interact with. According to the example above, the recommendation network predicts the next item to be a smart phone protective case. Given the purchase history of a phone charger, a headset, and a smart phone, the recommendation network recommends a smart phone protective case to the user (e.g., send a promotion email enclosing the next item to the user, display a picture of the next item in the advertisement area on the user's screen or a user device). In some cases, the operations of this step refer to, or may be performed by, a user interface as described with reference to FIG. 3.

An apparatus for item recommendation is also described. The apparatus includes a processor, memory in electronic communication with the processor, and instructions stored in the memory. The instructions are operable to cause the processor to identify a sequence of items selected by a user, embed each item of the sequence of items to produce item embeddings having a reduced number of dimensions, predict a next item based on the item embeddings using a recommendation network, wherein the recommendation network comprises a sequential encoder trained based at least in part on a sampled softmax classifier, and wherein predicting the next item represents a prediction that the user will interact with the next item, and provide a recommendation to the user, wherein the recommendation includes the next item.

A non-transitory computer readable medium storing code for item recommendation is also described. In some examples, the code comprises instructions executable by a processor to: identify a sequence of items selected by a user, embed each item of the sequence of items to produce item embeddings having a reduced number of dimensions, predict a next item based on the item embeddings using a recommendation network, wherein the recommendation network comprises a sequential encoder trained based at least in part on a sampled softmax classifier, and wherein predicting the next item represents a prediction that the user will interact with the next item, and provide a recommendation to the user, wherein the recommendation includes the next item.

Some examples of the method, apparatus, and non-transitory computer readable medium described above further include combining the item embeddings to form a session embedding, wherein the recommendation network takes the session embedding as an input. Some examples of the method, apparatus, and non-transitory computer readable medium described above further include encoding the session embedding to produce a session encoding, wherein the session encoding comprises contextual information from the sequence of items.

Some examples of the method, apparatus, and non-transitory computer readable medium described above further include applying a classifier to the session encoding, wherein the next item is selected based on the classifier. In some examples, the items comprise audio, video, or image files. In some examples, the recommendation network comprises a transformer network.

### Training and Evaluation

FIG. 7 shows an example of a process for training a recommendation network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

A method for training a recommendation network is described. Embodiments of the method are configured to identify a plurality of training sessions, wherein each training session comprises a sequence of items, predict a plurality of logits for each of the training sessions using a recommendation network, sample a subset of the logits, apply a sampled softmax classifier based on the sampled subset of the logits, and update parameters of the recommendation network based on the sampled softmax classifier.

In some cases, statistical language models are able to train a feedforward neural network to approximate probabilities over sequences of words, but training the neural network model with the maximum-likelihood criterion depends on computations proportional to the number of words in the vocabulary, for example. Adaptive importance sampling method may be introduced so as to accelerate training of the network model. In some cases, an adaptive n-gram model was used to track the conditional distributions produced by the neural network, in which results show significant increase in speed. In some cases, adaptive importance sampling method is used to accelerate training of a neural probabilistic language model.

In some examples, a training method based on adaptive importance sampling is used to decrease training time (e.g., increase speed in training by a factor of 150). The adaptive importance sampling method may be used to train a model from which learning and sampling are efficient (e.g., n-gram based) to track the neural network. During training of the neural network, when a word is presented in its context, instead of increasing its conditional likelihood and decreasing the conditional likelihood of all other words, it is sufficient to decrease the conditional likelihood of a few negative examples. These negative examples are sampled from the efficient n-gram-based model that tracks the relative conditional probabilities of the neural network language model.

The training method is based on decomposing gradient of the log-likelihood into two parts, which are positive and negative contributions. The negative contribution is hard to compute because it involves a number of passes through the network equivalent to the size of the vocabulary. However, the negative contribution can be estimated efficiently by importance sampling. An increase in training speed can be obtained by adapting the proposal distribution as training progresses so that it stays as close as possible to the network's distribution. In some examples, the training method includes reusing the sampled words to reweight the probabilities given by a n-gram.

According to some embodiments, sampled softmax is used to accelerate the softmax calculation. Experiments and evaluation show that with the parallel computing, softmax forward and backward calculation will not be the bottleneck of training. But it may lead to expensive GPUs memory usage, resulting in a limitation on the batch size that can be used in the training phase.

Suppose batch size is B, masking size of each sequence is M and the output space size is |l|. In some cases, double is used to represent the predicted probability P(i) for each i∈|I|. For a large-scale dataset, if |I|=2×10⁶, and M=40, the probability vector will cost about M×|I|×size of (double)≈0.96 gigabytes (GB). Given the GPU memory cost of single sample, it is difficult to train the large-scale dataset in a common batch size setting, (e.g., B=256) efficiently. As a comparison, in some cases, the public dataset used are less than 5×10⁴, resulting in about 16 megabytes (MB) GPU memory cost. Therefore, among industrial applications, sampled softmax can be used to train a BERT-like model with large batch size. Sampled softmax can decrease consumption of GPU memory and prevent accuracy loss.

According to an embodiment, one step in a gradient-based approach to train the network model involves computing the gradient of the log-likelihood P(I=i) with respect to parameters Θ. The gradient can be decomposed into two parts, which are positive reinforcement for the observed value I=i and negative reinforcement for every j, weighted by P(Ĩ=j) by differentiating the negative logarithm with respect to Θ.

At operation 700, the system identifies a set of training sessions, where each training session includes a sequence of items. In some cases, the operations of this step refer to, or may be performed by, a training component as described with reference to FIG. 3.

At operation 705, the system predicts a set of logits for each of the training sessions using a recommendation network. In some cases, the operations of this step refer to, or may be performed by, a recommendation network as described with reference to FIGS. 1 and 3.

One embodiment of the present disclosure uses Φ=Vh^{K}_{j,t}^{T}+b_{O} to denote the logits obtained before the softmax layer and Θ to denote the trainable model parameters. The gradient of negative log-likelihood ∇_{Θ} (−log P(i)) is formulated as follows:

$${∇}_{Θ} ( - log P ( i ) ) = {∇}_{Θ} {Φ}_{i} - {\sum }_{j ∈ I} P ( j ) {∇}_{Θ} {Φ}_{j} \qquad ( 6 )$$

At operation 710, the system samples a subset of the logits. In some cases, the operations of this step refer to, or may be performed by, an output layer as described with reference to FIGS. 3 and 4.

The last term Σ_{j∈I}P(j)∇_{Θ}Φⱼ=E_{P}[∇_{Θ}Φ], so the recommendation network samples a subset of candidates Ĩ⊂I containing the positive item i to estimate the expectation of ∇_{θ}Φⱼ,

$${E}_{P} [ {∇}_{Θ} Φ ] \approx {\sum }_{j ∈ I} \tilde{P} ( j ) {∇}_{Θ} {Φ}_{j} \qquad ( 7 )$$

where \tilde{P}(j) is obtained from the softmax over the logits of the subset Ĩ⊂I. According to some embodiments, the softmax is converted to a sampled version:

$$P ( i ) = \frac{exp ( - {Φ}_{i} )}{{\sum }_{j ∈ I} exp ( - {Φ}_{j} )} \to \tilde{P} ( i ) = \frac{exp ( - {Φ}_{i} )}{{\sum }_{j ∈ I} exp ( - {Φ}_{j} )} , where \vert \tilde{I} \vert ⪡ \vert I \vert \qquad ( 8 )$$

According to an embodiment, a small subset is used to estimate the gradient from the whole candidate pool. Referring to the example of 0.96 GB GPUs memory consumption, the network model uses about 8000 samples to replace the full-softmax of 3×10⁶ items and reduce the probability size to 2.56 MB.

At operation 715, the system applies a sampled softmax classifier based on the sampled subset of the logits. In some cases, the operations of this step refer to, or may be performed by, an output layer as described with reference to FIGS. 3 and 4.

According to an embodiment, sampling is performed using a GPU (i.e., speed is much faster and the large-scale training becomes practical). One difference between GPUs and CPUs is that GPUs devote proportionally more transistors to arithmetic logic units and fewer to caches and flow control as compared to CPUs. A GPU includes more logical cores (arithmetic logic units or ALUs, control units and memory cache) than a CPU. According to an embodiment, the recommendation network performs sampling on GPUs. Sampling is an additional overhead for training, which is slow on central CPUs, even with the help of single instruction, multiple data (SIMD).

At operation 720, the system updates parameters of the recommendation network based on the sampled softmax classifier. In some cases, the operations of this step refer to, or may be performed by, a training component as described with reference to FIG. 3.

In some examples, a supervised training model may be used that includes a loss function that compares predictions of the network with ground truth training data. The term loss function refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly, and a new set of predictions are mode during the next iteration.

An apparatus for training a recommendation network is also described. The apparatus includes a processor, memory in electronic communication with the processor, and instructions stored in the memory. The instructions are operable to cause the processor to identify a plurality of training sessions, wherein each training session comprises a sequence of items, predict a plurality of logits for each of the training sessions using a recommendation network, sample a subset of the logits, apply a sampled softmax classifier based on the sampled subset of the logits, and update parameters of the recommendation network based on the sampled softmax classifier.

A non-transitory computer readable medium storing code for training a recommendation network is also described. In some examples, the code comprises instructions executable by a processor to identify a plurality of training sessions, wherein each training session comprises a sequence of items, predict a plurality of logits for each of the training sessions using a recommendation network, sample a subset of the logits, apply a sampled softmax classifier based on the sampled subset of the logits, and update parameters of the recommendation network based on the sampled softmax classifier.

Some examples of the method, apparatus, and non-transitory computer readable medium described above further include embedding each item of the sequence into a low-dimensional embedding space to produce item embeddings, wherein the low-dimensional embedding space has fewer dimensions than an item from the sequence. Some examples further include combining the item embeddings to form a session embedding.

Some examples of the method, apparatus, and non-transitory computer readable medium described above further include encoding the session embedding to produce a session encoding, wherein the session encoding comprises contextual information from the sequence. In some examples, the sampling is based on a negative sampling technique.

Some examples of the method, apparatus, and non-transitory computer readable medium described above further include computing a gradient of the parameters based on the subset of the logits, wherein the sampled softmax classifier is based on the gradient of the parameters. In some examples, the sampling is performed using a GPU.

Some examples of the method, apparatus, and non-transitory computer readable medium described above further include updating the parameters during a plurality of iterations to train the recommendation network.

Some examples of the method, apparatus, and non-transitory computer readable medium described above further include sampling a different random subset of the logits during each of the plurality of iterations.

Performance of the apparatus and methods of the present disclosure have been evaluated, and results indicate the embodiments of the present disclosure provide an improvement over existing technology. The recommendation network is implemented and trained on three datasets. Experiments demonstrate that the effectiveness of projection layer removal and the speed is increased using sampled softmax techniques.

Recently, existing BERT-like recommendation systems follow the “masked token” softmax classifier for training, which achieve the highest ranking scores (e.g. NDCG, HitRatio) in several public datasets, such as MovieLens-1M (or ML-1M), ML-20M, Amazon® Beauty, etc. But the number of items in these public datasets is relatively small, for example, it is 3K for ML-1M, 26K for ML-20M and 54K for Amazon® Beauty. The number of items in large-scale industrial datasets is hundreds or thousands of times larger than the several public datasets. If BERT-like recommendation systems are applied on large-scale datasets, computation burden and GPUs memory usage are high and expensive. However, the recommendation network of the present disclosure is scalable and can be efficiently trained on large datasets.

Three datasets are used to evaluate apparatus and methods of the present disclosure. Beauty is a dataset collected from Amazon® Reviews. The whole Amazon® data is split into separate categories and Beauty category is used here. The evaluation follows the splitting strategy for a comparison with a conventional BERT model. Here each user behavior history is viewed as a single session.

Stock-5-Core is a dataset collected from Adobe® Stock platform from April 22, to Apr. 29, 2020. This data is split into sessions by the session_id provided by platform and includes image clicks sequences. The data are preprocessed by filtering out the sessions and items whose length or frequency are less than five to build a relatively dense 5-core dataset.

Stock-5-Length is a dataset collected as Stock-5-Core but the preprocessing is more relaxed, and the evaluation includes filtering out the short sessions whose length is less than five without any constraints on items. Therefore, the item size is more than 3M, which is much larger than the previous two datasets and closer to the real-world scenario.

The evaluation protocol and data split include forming a training set, a validation set, and a testing set. The evaluation also includes using the truncated HitRatio (referred to as HR@K) and Normalized Discounted Cumulative Gain (referred to as NDCG@K). The candidates list used in evaluation is as follows:

For Beauty dataset, the evaluation is accelerated by sampling 100 negative items. The evaluation negative candidates are selected from the negative pool with the probability of popularity (i.e., the frequency of each item in data). For fair comparisons, the same evaluation strategy is used for Beauty dataset.

For the Stock dataset, the evaluation does not include sampling negative items. Instead, all the items in the item pool are used to form the candidates list. In some cases, GPUs are used to accelerate the evaluation. The recommendation evaluation under sampling may be inconsistent, so the whole candidates list is used for ranking.

The effectiveness of the projection layer removal is evaluated, and results are recorded. Based on projection layer removal study on Beauty and Stock-5-Core, experimental results show that first, the hyper-parameters of a BERTA model was tuned on Beauty carefully, to obtain a higher performance than the reported scores. Second, if the projection layer (PROJ) is removed, the ranking performance is increased significantly for both Beauty and Stock-5-Core datasets. The sparsity of recommendation dataset makes it difficult to apply BERT architecture in NLP to recommendation directly, it often leads to overfitting. And the projection layer removal reduces the model capacity and contributes to the generalization of the recommendation network.

The effectiveness of sampled softmax is evaluated, and results are recorded. Effectiveness of sampled softmax on Beauty and Stock dataset is recorded based on experiments. Experimental results show the relationship between sampling size with the model performance including convergence speed, output size and ranking quality on testing set. First, the results show that less negative samples may lead to slower convergence. As the Conv. Epochs for each dataset shown, if the network model samples less candidates, the model depends on more iterations for convergence. Even though the time consumption (sec/epoch) for each epoch is smaller, only selecting one negative item is still unacceptable for training efficiency. For example, on Beauty, the total training time is about 199 sec for the full-softmax BERT, but about 5.8 sec for Negs=1.

Second, with more negative samples, sampled-softmax is closer to full-softmax. For Beauty and Stock-5-Core datasets, if the network model samples over 1000 negatives, the accuracy is closer to the full-softmax version. And the sec/epoch shows that with the GPUs-based sampling implementation, the sampling time is not the bottleneck with the samples size growing.

Third, the network model can achieve comparable accuracy, but has a much smaller output size. Out size/sample shows the output probability vector size for each data sample, where the expected prediction numbers are 30, 24, 24 for Beauty, 5-core, 5-length datasets respectively. For Amazon® Beauty dataset, the output probability size is reduced from 13.91 MB to less than 2.40 MB, and in the Stock-5-Core dataset, the output probability size is reduced from 23.54 MB to 1.92 MB without obvious accuracy drop, showing the effectiveness of the sampled softmax in a BERT model. In the large dataset stock-5-length, the output probability size is reduced from 640.76 MB to 1.54 MB, make it feasible to apply large batch size for efficient training.

Embodiments of the present disclosure provide a sequential recommendation system for large-scale industrial dataset. Large output space size in industrial dataset results in expensive GPUs memory usage, therefore, it is challenging to apply large batch size for training. To address this issue, some embodiments of the present disclosure provide an improved recommendation network that is configured to remove the projection layer, apply sampled softmax and implement sampling on GPUs to significantly reduce the memory consumption in training and accelerate speed of training while maintaining accuracy. The effectiveness of projection removal and sampled softmax are evaluated on datasets (e.g., Amazon® Beauty, Adobe® Stock datasets) as above.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for item recommendation, comprising:
identifying a sequence of items selected by a user;
embedding each item of the sequence of items to produce item embeddings having a reduced number of dimensions;
predicting a next item based on the item embeddings using a recommendation network, wherein the recommendation network comprises an encoder trained based at least in part on a sampled softmax classifier, and wherein predicting the next item represents a prediction that the user will interact with the next item; and
providing a recommendation to the user, wherein the recommendation includes the next item.

2. The method of claim 1, further comprising:
combining the item embeddings to form a session embedding, wherein the recommendation network takes the session embedding as an input.

3. The method of claim 2, further comprising:
encoding the session embedding to produce a session encoding, wherein the session encoding comprises contextual information from the sequence of items.

4. The method of claim 3, further comprising:
applying a classifier to the session encoding, wherein the next item is selected based on the classifier.

5. The method of claim 1, wherein:
the items comprise audio, video, or image files.

6. The method of claim 1, wherein:
the recommendation network comprises a transformer network.

7. An apparatus for item recommendation, comprising:
an embedding layer configured to embed a sequence of items from a session into an embedding space to produce a session embedding;
a transformer block configured to encode the session embedding to produce a session encoding; and
an output layer configured to predict a next item for the session based on the session encoding, wherein a recommendation network is trained based at least on a sampled softmax classifier of the output layer.

8. The apparatus of claim 7, wherein:
the embedding layer is configured to embed each item of the sequence into a low-dimensional embedding space to produce item embeddings, wherein the low-dimensional embedding space has fewer dimensions than an item from the sequence.

9. The apparatus of claim 7, wherein:
the transformer block comprises a plurality of transformer modules, each of the transformer modules comprises a multi-head self-attention layer and a position-wise feed-forward layer.

10. The apparatus of claim 7, wherein:
the recommendation network is based on a bidirectional encoder representations from transformers (BERT) architecture.

11. The apparatus of claim 10, wherein:
the output layer does not include a projection layer.

12. The apparatus of claim 7, further comprising:
a graphics processing unit (GPU) configured to perform sampling for the sampled softmax classifier.

13. A method for training a recommendation network, comprising:
identifying a plurality of training sessions, wherein each training session comprises a sequence of items;
predicting a plurality of logits for each of the training sessions using a recommendation network;
sampling a subset of the logits;
applying a sampled softmax classifier based on the sampled subset of the logits; and
updating parameters of the recommendation network based on the sampled softmax classifier.

14. The method of claim 13, further comprising:
embedding each item of the sequence into a low-dimensional embedding space to produce item embeddings, wherein the low-dimensional embedding space has fewer dimensions than an item from the sequence; and
combining the item embeddings to form a session embedding.

15. The method of claim 14, further comprising:
encoding the session embedding to produce a session encoding, wherein the session encoding comprises contextual information from the sequence.

16. The method of claim 13, wherein:
the sampling is based on a negative sampling technique.

17. The method of claim 13, further comprising:
computing a gradient of the parameters based on the subset of the logits, wherein the sampled softmax classifier is based on the gradient of the parameters.

18. The method of claim 13, wherein:
the sampling is performed using a graphics processing unit (GPU).

19. The method of claim 13, further comprising:
updating the parameters during a plurality of iterations to train the recommendation network.

20. The method of claim 19, further comprising:
sampling a different random subset of the logits during each of the plurality of iterations.
